(19) United States
(12) Patent Application Publication
(10) Pub. No.: US 2024/0412443 A1
(43) Pub. Date: Dec. 12, 2024

(54) INFORMATION PROCESSING DEVICE, AND INFORMATION PROCESSING METHOD

(71) Applicant: Morgenrot Inc., Tokyo (JP)

(72) Inventors: Takahiro HARADA, Tokyo (JP); Mehmet Oguz DERIN, Tokyo (JP)

(21) Appl. No.: 18/702,081

(22) PCT Filed: Sep. 28, 2022
(86) PCT No.: PCT/JP2022/036274

§ 371 Date: Jul. 8, 2024

Related U.S. Application Data
(60) Provisional application No. 63/270,372, filed on Oct. 21, 2021.

(51) Int. Cl. G06T 15/00; G06T 15/06

(52) U.S. Cl. CPC G06T 15/005; G06T 15/06

(57) ABSTRACT

An information processing device including a GPU having an RT core unit for executing, using hardware, ray tracing on a predetermined three-dimensional space in which an object is included, an HWRT processing control unit 91 executes a control for causing an RT core 12H to execute ray tracing on a passage block. A WALK processing unit 92 executes ray tracing on the processing block by software processing. When a ray enters the processing block during execution of the ray tracing by the RT core 12H, a HWRT/WALK switching unit 93 switches to processing by the WALK processing unit 92. When a ray enters a passage block during execution of the software processing by the WALK processing unit 92, the HWRT/WALK switching unit 93 switches to processing by the RT core 12H. When a ray enters an adjacent processing block, switching to processing by the RT core unit 12H is prohibited.

### TECHNICAL FIELD

The present invention relates to an information processing device and an information processing method.

### BACKGROUND ART

Conventionally, there has been a technique for using a method of volume rendering to generate, from a three-dimensional image (many two-dimensional, cross-sectional images) in which a photographing target is included, a two dimensional image (a semitransparent, pseudo three-dimensional image) when the photographing target is viewed (for example, see Patent Document 1).

### CITATION LIST

### Patent Document

Patent Document 1: Japanese Unexamined Patent Application, Publication No. 2008-259696

### DISCLOSURE OF THE INVENTION

### Problems to be Solved by the Invention

However, in conventional techniques including one described in Patent Document 1 described above, processing has merely been executed for each of voxels in a three-dimensional image to calculate and generate, as an output image, a two dimensional image when a target serving as a photographing target is viewed from a predetermined point of view. As a result, there have been an increased period of time of calculation and an increased cost of preliminary processing on data when volume rendering is performed based on high-definition data including many voxels.

In view of the situations described above, an object of the present invention is to reduce a cost of volume rendering.

### Means for Solving the Problems

To achieve the object described above, an information processing device according to an aspect of the present invention is an information processing device including:
a graphics processing unit (GPU) including a ray tracing (RT) core unit that executes, in a hardware manner, ray tracing on a predetermined three-dimensional space in which a target is included; and
a central processing unit (CPU) that executes information processing, in which
the CPU or the GPU includes:
an acquisition unit that acquires, when a three-dimensional body having a predetermined size is regarded as a unit three-dimensional body, data in which the predetermined three-dimensional space is divided into a plurality of the unit three-dimensional bodies, as first data; a second data generation unit that divides, when an n-number of the unit three-dimensional bodies are regarded as a block, the first data into a plurality of the blocks, that identifies, among the plurality of blocks, one or more of the blocks, the one or more of the blocks each including the unit three-dimensional body corresponding to a part of the target, as processing blocks, and identifies other ones of the blocks as pass-through blocks, and that generates, as second data, the first data divided into the processing blocks or the pass-through blocks; and an execution control unit that controls execution of ray tracing on the second data, and
the execution control unit includes:
a ray tracing execution control unit that executes control of executing ray tracing by the RT core unit on the pass-through blocks in the second data;
a software execution unit that executes ray tracing by software processing on the second data; and
a switching means that, while the ray tracing by the RT core unit is executed, when a ray enters one of the processing blocks, causes switching to the ray tracing by the software processing to occur, and, while the ray tracing by the software processing is executed, when the ray enters one of the pass-through blocks, causes switching to the ray tracing by the RT core unit to occur, or, when the ray enters an adjacent one of the processing blocks, prohibits switching to the ray tracing by the RT core unit from occurring.

An information processing method according to the aspect of the present invention is an information processing method corresponding to the information processing device according to the aspect of the present invention described above.

### Effects of the Invention

According to the present invention, it is possible to reduce a cost of volume rendering.

### BRIEF DESCRIPTION OF THE DRAWINGS

FIG. 1 is a view illustrating an outline of a present service that becomes feasible with a rendering device relating to an embodiment of an information processing device according to the present invention;

FIG. 2 is a view illustrating an example of blocks and voxels in a slice illustrated in FIG. 1;

FIG. 3 is a view illustrating an example of blocks and voxels in a two-dimensional slice;

FIG. 4 is a view illustrating an outline of processing of ray tracing applied to the rendering device in the present service illustrated in FIG. 1;

FIG. 5 is a view illustrating an outline of a mask for achieving further efficient ray tracing executed by the rendering device in the present service illustrated in FIG. 1;

FIG. 6 is a block diagram illustrating an example of a hardware configuration of the rendering device applied in the present service described with reference to FIGS. 1 to 5, that is, the rendering device relating to the embodiment of the information processing device according to the present invention;

FIG. 7 is a functional block diagram illustrating an example of a functional configuration of the rendering device illustrated in FIG. 6;

FIG. 8 is a state transition diagram illustrating an example of state transitions in the rendering device having the functional configuration illustrated in FIG. 7;

FIG. 9 is a flowchart for describing an example of a flow of volume rendering processing executed by the rendering device having the functional configuration illustrated in FIG. 7; and

FIG. 10 is a flowchart for describing an example of a flow of ray tracing processing for each of pixels in an output image, in the flow of the volume rendering processing illustrated in FIG. 9.

### PREFERRED MODE FOR CARRYING OUT THE INVENTION

An embodiment of the present invention will now be described herein with reference to the accompanying drawings.

An embodiment of an information processing device according to the present invention is configured on the premise that volume rendering is used. That is, in a service (hereinafter referred to as “the present service”) to which the embodiment of the information processing device according to the present invention is applied, volume rendering is performed on a predetermined target that is present in a real world.

Volume rendering refers to generating, based on three-dimensionally expanding data relating to a target, data of a two dimensional image in which an object of the target is included. For example, a group of pieces of data of a series of two-dimensional slices, which is acquired as computed tomography (CT) or magnetic resonance imaging (MRI) is performed on a target in the real world, is an example of the three-dimensionally expanding data. For example, volume rendering makes it possible, based on three-dimensionally expanding data relating to a target, as described above, to generate data of a two dimensional image, in which it is possible to view an internal structure of the target in another angle than that when a two-dimensional slice is viewed. Note that the term “data” in the term “data of an image” will be omitted in the below description. That is, those described with “image” in the description as information processing mean “data of an image”, unless otherwise stated. A device that performs home rendering as described above to generate a two dimensional image will be hereinafter referred to as a “rendering device”. That is, as the embodiment of the information processing device according to the present invention, a rendering device is adopted.

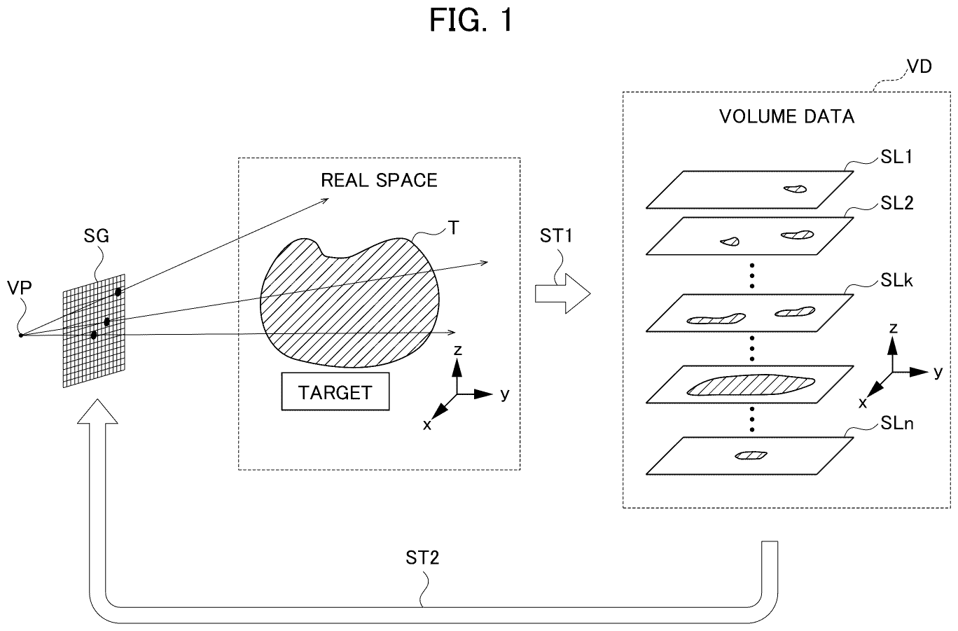

FIG. 1 is a view illustrating an outline of the present service that becomes feasible with the rendering device relating to the embodiment of the information processing device according to the present invention.

In the present embodiment, it will be described herein that a mineral is adopted as a target T, for example. As illustrated in FIG. 1, the target T is present in a three-dimensional real space having an axis X, an axis Y, and an axis Z. That is, the rendering device in the present service performs volume rendering to generate, from three-dimensionally expanding data VD (hereinafter referred to as “volume data VD”), a two dimensional image SG (hereinafter referred to as an “output image SG”). A flow of the present service executed by the rendering device will now be described herein.

In step ST1, volume data VD is first generated from the target T. Note that the volume data VD may be generated by the rendering device or may be generated by another device and provided to the rendering device. In the example illustrated in FIG. 1, the volume data VD includes a group of pieces of data of a series of slices SL1 to SLn (n is an integer value equal to or more than 2) pertaining to the target T. Specifically, for example, the slices SL1 to SLn in the example illustrated in FIG. 1 are pieces of data, which indicate the target T thinly sliced in a positive direction along the axis Z. In the below description of the present embodiment, it is assumed that a group of pieces of data of an n-number of images (n=1000) each photographed in the positive direction along the axis Z for those acquired as a result of thinly slicing, in parallel to the axis X and the axis Y, the target T in the real world n times (n=10000) in a direction along the axis Z have been acquired beforehand as the slices SL1 to SLn. That is, it will be described herein that the n-number of the slices SL1 to SLn (n=1000) have been acquired beforehand as the volume data VD.

In step ST2, the rendering device executes volume rendering to generate an output image SG corresponding to one when the target T (the volume data VD including an object of the target T, in terms of processing) is viewed from a point of view VP that is present at a predetermined position. Specifically, for example, whether or not the target T serving as a target to be outputted is present on a straight line starting from the predetermined point of view VP and passing through a predetermined pixel in the output image SG, and distribution of density and a thickness of the target T, for example, are reflected to determine a pixel value of the predetermined pixel. For example, the rendering device sequentially sets each of the pixels forming the output image SG as a focusing-on pixel and repeatedly executes such processing on the focusing-on pixel to generate the output image SG.

The present service that makes it possible to generate such an output image SG has features described below. That is, the volume data VD is three-dimensionally high-definition data acquired using a method of destructing the target T, compared with data (when the target is a brain, for example, data indicating a three-dimensional arrangement of blood vessels in the brain) acquired using a non-destructive method such as MRI. As a result, an output image SG generated using volume rendering on such volume data VD is high in image quality, compared with an image generated using a non-destructive method. However, if a rendering device that has been present conventionally is adopted, instead of the rendering device in the present service, there has been an issue of a longer period of time taken for volume rendering due to such high-definition volume data VD. Therefore, to solve the issue described above, there are some measures taken in the rendering device in the present service to promptly execute volume rendering on such high-definition volume data VD. The measures will now be described herein.

Note herein that the slices SL1 to SLn each include a part (an object) of the target T only in its partial region. Specifically, for example, a slice SLk (k is an integer value equal to or more than 1 and equal to or less than n) includes regions in which two parts (objects) of the target T are included. That is, another region in the slice SLk is a region indicating a blank space in which the target T is not present.

In the rendering device in the present service, a technique called ray tracing described below is adopted to achieve prompt processing on a region of a blank space in which the target T is not present. That is, when a part of the target T (the volume data VD, in terms of processing), which is present on a straight line starting from the predetermined point of view VP and passing through a predetermined pixel in an output image SG, is viewed, a beam of light normally advances from the target T along the straight line toward the point of view VP. One that advances in a direction opposite to the direction in which the actual beam of light advances will be hereinafter referred to as a “ray”. A method of determining a pixel value of the predetermined pixel based on, for example, whether or not, when the ray is caused to advance along the straight line described above, the ray reaches a predetermined part of the target T that is present in the three-dimensional space is referred to as ray tracing. That is, ray tracing is a method of tracing a ray advancing along the straight line starting from the predetermined point of view VP and passing through a predetermined pixel in an output image SG to simulate a pixel value of the predetermined pixel.

As will be described later in detail, the technique called ray tracing makes it possible to promptly calculate how long a blank space where the target T is not present continues in a trajectory of a ray, that is, the position where the ray advancing along the straight line collides with the target T. Thereby, processing on a blank space where the target T is not included is skipped, leading to improved, efficient processing of generating an output image SG.

Note herein that a graphics processing unit (GPU) is normally used as a device provided in a rendering device for generating an output image SG. The GPU is specialized for image processing, and includes many units and many cores for promptly executing various types of processing on many pixels to promptly generate an output image SG. That is, although a GPU has been provided with a plurality of computing units, a core for executing ray tracing in a hardware manner (hereinafter referred to as a “ray tracing (RT) core”) is further provided in recent years. The RT core is a type of hardware that makes it possible to promptly execute processing of ray tracing. That is, the RT core is used to execute processing on a blank space where a target T is not present, making it possible to achieve prompt processing. In other words, the RT core is a type of hardware specialized for processing on the blank space where the target T is not present in ray tracing.

However, when volume rendering is to be executed, it is difficult to cause processing in the RT core (hardware processing) to cover all types of processing, and processing in the computing unit (software processing) is used in a combined manner. That is, when volume rendering is to be executed, a transition from one to another, that is, between the processing in the RT core and the processing in the computing unit is required. Specifically, for example, when a ray advances along a straight line passing through a predetermined pixel in an output image SG, processing on a blank space where a target T is not included is required at a point in time of starting the processing, and the processing in the RT core is thus executed.

Then, when the ray collides with the target T as a result of the processing in the RT core, the processing in the computing unit is executed afterward for those ahead of a three-dimensional coordinate at which the ray has collided with the target T, on the straight line starting from the predetermined point of view VP and passing through the predetermined pixel in the output image SG. Furthermore, when there is a possibility that the ray reaches a blank space as a result that the processing in the computing unit has been executed, the processing in the RT core is executed afterward for those ahead of a three-dimensional coordinate at which there is a possibility that the ray reaches a blank space, on the straight line starting from the predetermined point of view VP and passing through the predetermined pixel in the output image SG. In conventional volume rendering, such an issue has been present that a transition itself from the processing in the computing unit to the processing in the RT core as described above takes more time. Therefore, in the rendering device in the present service, a method of reducing a number of times of the transitions is adopted, making it possible to promptly generate an output image SG.

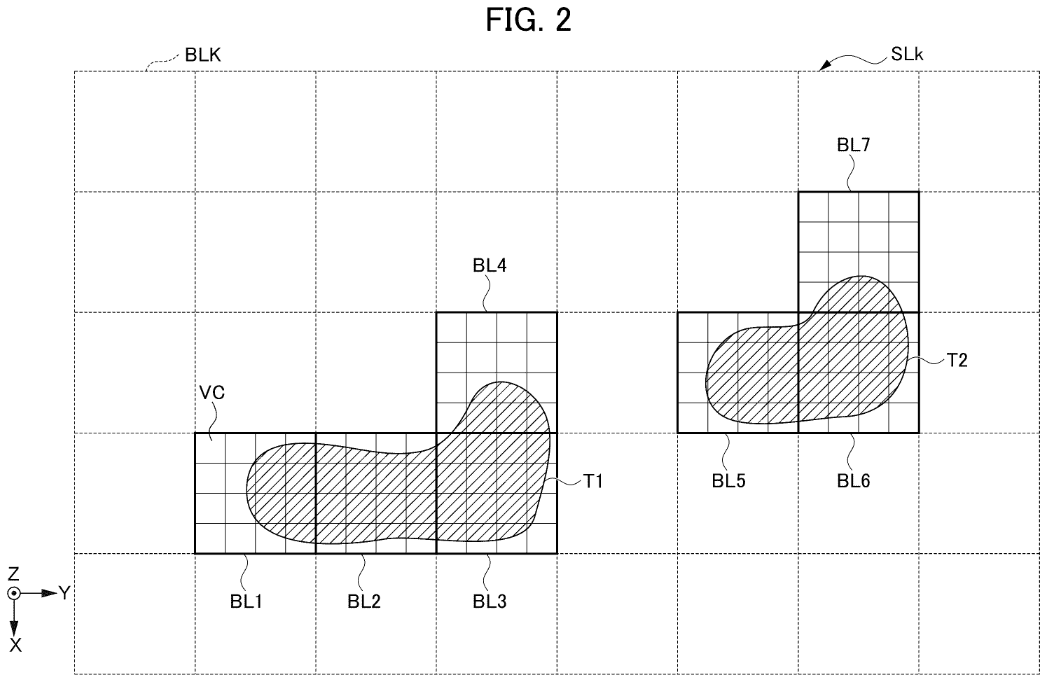

As a prerequisite for describing the method of reducing a number of times of transitions from the processing in the computing unit to the processing in the RT core, a concept of blocks and voxels used in processing of ray tracing will first be described with reference to FIG. 2. FIG. 2 is a view illustrating an example of blocks and voxels in a slice illustrated in FIG. 1.

As illustrated in FIG. 2, each of regions acquired as a result that the slice SLk has been divided into predetermined first units is a voxel VC. Performing processing in a unit of voxel VC is less efficient. Therefore, regions acquired as a result that the slice SLk has been divided into second units, each larger than a first unit, in other words, regions each including a group of an n-number of voxels are introduced as blocks BL1 to BL7 and BLK. In the example illustrated in FIG. 2, n is a total of four in a direction along the axis X, four in a direction along the axis Y, and one in the direction along the axis Z, which is eight. Note that this will be expressed as “x×y” since there is one in the direction along the axis Z. That is, each of the blocks BL1 to BL7 includes an n-number of the voxels VC (n=4×4). When it is not necessary to distinguish a plurality of voxels from each other, each voxel will be hereinafter referred to as a “voxel VC”. Similarly, when it is not necessary to distinguish the blocks BL1 to BL7, for example, from each other, each block will be hereinafter referred to as a “block BL”.

The regions of the blocks BL, which are each indicated by a thick line illustrated in FIG. 2, are regions that may include objects of two parts that are a part T1 and a part T2 of the target T, respectively. That is, in a standpoint of data called the slice SLk, those actually included are not parts of the target T in the real world, but are objects. However, for purposes of description, an “object” may be described in a simplified manner. That is, in data, those for which it is described that a material body in the real world is included mean that an object of the material body is included, unless otherwise stated. In the slice SLk, a block BL that may include a part of the target T and a block BLK that is a blank space are distinguished from each other in ray tracing. While the former block, that is, the block BL is reflected on a pixel value of a predetermined pixel in an output image SG, the latter block, that is, the block BLK is not reflected. Therefore, the former block, that is, the block BL will be hereinafter referred to as a “processing block BL”, and the latter block, that is, the block BLK will be hereinafter referred to as a “pass-through block BLK”.

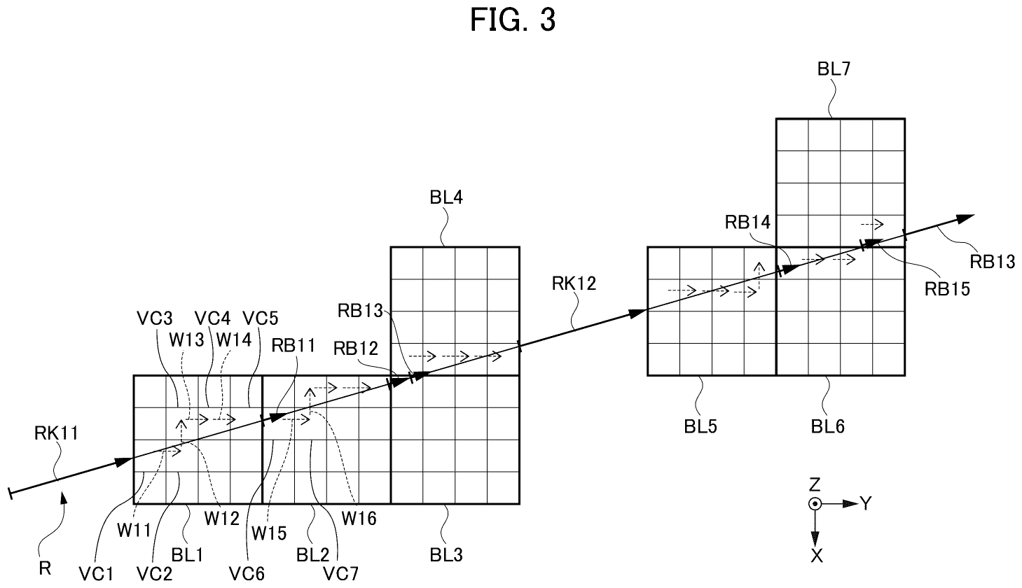

In FIG. 2, to facilitate understanding of the present invention, the “processing blocks BL” are illustrated with thick lines, and the “pass-through blocks BLK” are illustrated with broken lines. Note that, in FIGS. 3 to 5, only the “processing blocks BL” are illustrated. Specifically, for example, in the example illustrated in FIG. 2, the slice SLk has regions that may respectively include two parts, being the part T1 and the part T2 of the target T. As the regions that may include the part T1 of the target T, the four processing blocks BL1 to BL4 are illustrated. Furthermore, as the regions that may include the part T2 of the target T, the three processing blocks BL5 to BL7 are illustrated.

Next, an outline of conventional processing of ray tracing will now be described with reference to FIG. 3. FIG. 3 is a view illustrating an example of blocks and voxels in a two-dimensional slice.

In the processing in the RT core (hardware processing), the processing is normally executed based on information relating to an axis-aligned bounding box (AABB). Note herein that an AABB has a rectangular parallelepiped shape defined by a pair of a minimum value and a maximum value on each of the axis X, the axis Y, and the axis Z in a three-dimensional space. In the processing in the RT core, a ray R is allowed to extend in a pseudo manner into a virtual space in which a plurality of AABBs described above are disposed to calculate a three-dimensional coordinate at which a collision of the ray R occurs.

It will be described herein that, in the rendering device in the present service, it is assumed that the processing in the RT core is executed on AABBs that are a plurality of the processing blocks BL described above. That is, in the processing in the RT core (hardware processing), a three-dimensional coordinate at which the ray R collides with one of the processing blocks BL is to be calculated. Furthermore, it will be described herein that, in the processing in the RT core (hardware processing), a collision with each of the processing blocks BL is to be determined.

Thick-line arrows indicate trajectories of the ray R (advancing in a direction opposite to a direction in which an actual beam of light advances) allowed to extend under the processing in the RT core. Such a trajectory will be hereinafter referred to as an “RT-core-processing trajectory”. In the example illustrated in FIG. 3, RT-core-processing trajectories RK11 to RK13 and RT-core-processing trajectories RB1 to RB15 are illustrated. The RT-core-processing trajectories RK11 to RK13 indicate trajectories where ray tracing is performed in the pass-through blocks BLK under the processing in the RT core. In other words, since the pass-through blocks BLK are blocks BL where the target T is not present (no collision of the ray R occurs), the ray R is allowed to extend under the processing in the RT core. That is, pieces of processing, which are indicated as the RT-core-processing trajectories RK11 to RK13, are executed by the RT core. Note that the RT-core-processing trajectories RB11 to RB15 will be described later.

When those ahead of the arrows of the RT-core-processing trajectories RK11 and RK12 are viewed, dotted-line arrows W11 to W16, for example, which are not RT-core-processing trajectories, are illustrated. The arrows with dotted lines of the dotted-line arrows W11 to W16, for example, indicate trajectories of the ray R (advancing in the direction opposite to the direction in which the actual beam of light advances) allowed to extend under the processing in the computer unit (software processing). Such a trajectory will be hereinafter referred to as a “software-processing trajectory”. Note that the actual beam of light advances along the straight line along which the RT-core-processing trajectories RK11 and RK12 run. However, since a voxel VC serves as a minimum unit in information processing, the ray R is regarded to move in the direction along the axis X or the axis Y in a unit of the voxel VC in the processing in the computer unit. Therefore, the processing in the computer unit, which indicates such a software-processing trajectory, is referred to as “WALK processing”. A nodal point (a boundary) of an end point of the RT-core-processing trajectory RK11 and a start point of the software-processing trajectory W11 represents a point at which the ray R collides with the processing block BL1. That is, as the ray R collides with the processing block BL1, a transition occurs from the processing in the RT core to the WALK processing (software processing).

That is, as the ray R advancing along the RT-core-processing trajectory collides with the processing block BL, the processing block BL is regarded to be subject to processing, and the WALK processing is executed. Specifically, in the WALK processing, a voxel VC in the processing block BL, which corresponds to a three-dimensional coordinate at which the collision of the ray R has occurred, is first set as a voxel VC that is subject to processing. A voxel that is subject to the WALK processing and is thus focused on will be hereinafter referred to as a “focusing-on voxel VC”

A focusing-on voxel VC that has become subject to the WALK processing is used to determine a pixel value of a predetermined pixel in an output image SG. Then, in the processing block BL, such a focusing-on voxel VC is sequentially set for the voxels VC that the straight line along which the RT-core-processing trajectories RK11 and RK12 run crosses. Thereby, the ray R moves through the voxels VC in the processing block BL.

Specifically, in the WALK processing, first processing for judging a voxel VC that is adjacent in the advancing direction of the ray R, when viewed from the focusing-on voxel VC, is first executed. Such a voxel VC that is adjacent in the advancing direction of a ray R, when viewed from a focusing-on voxel VC, will be hereinafter referred to as an “adjacent voxel VC”. An adjacent voxel VC is a voxel VC that is adjacent in the direction along the axis X or the axis Y to a focusing-on voxel VC, and is a candidate that may be next set as a focusing-on voxel VC.

Next, second processing for determining whether or not the adjacent voxel VC as a result of the first processing (the adjacent voxel VC that is adjacent to the focusing-on voxel VC in the first processing) is a voxel VC in the processing block BL is executed. Then, when the adjacent voxel VC belongs to the identical processing block BL to which the focusing-on voxel VC belongs, as a result of the second processing, the WALK processing continues, and the adjacent voxel VC is set as a focusing-on voxel VC. The focusing-on voxel VC that is set as a result of the second processing is used to determine a pixel value of the predetermined pixel in the output image SG. After that, the first processing is further executed on the voxels VC to be set.

On the other hand, when the adjacent voxel VC does not belong to the identical block BL to which the focusing-on voxel VC belongs, as a result of the second processing, that is, when the adjacent voxel VC belongs to a different block BL, a point for which attention should be paid in here is a point that, in conventional WALK processing (conventional ray tracing), such “different blocks” may include not only pass-through blocks BLK, but also processing blocks BL. That is, it is determined, as a result of the second processing, whether or not transferring of processing from the WALK processing that is software processing to the processing in the RT core is allowed, and, when a voxel VC after movement belongs to a different block BL, transferring to the processing in the RT core is allowed regardless of whether or not the block is a pass-through block BLK or a processing block BL.

Specifically, for example, when a voxel VC1 illustrated in FIG. 3 is a focusing-on voxel, that is, when the voxel VC1 is set as the focusing-on voxel VC1 since the RT-core-processing trajectory RK11 has collided with the processing block BL1, the WALK processing proceeds as described below. That is, in the first processing, a voxel VC2 that is adjacent in the direction along the axis Y to the focusing-on voxel VC1 in the processing block BL1 is judged as the adjacent voxel VC2. Then, in the second processing, since the adjacent voxel VC2 belongs to the identical processing block BL1 to which the focusing-on voxel VC1 belongs, the WALK processing continues.

Next, the WALK processing described below is executed on the focusing-on voxel VC2. That is, in the first processing, a voxel VC3 that is adjacent in the direction along the axis X to the focusing-on voxel VC2 in the processing block BL1 is judged as the adjacent voxel VC3. Then, in the second processing, since the adjacent voxel VC3 belongs to the identical processing block BL1 to which the focusing-on voxel VC2 belongs, the WALK processing continues. After that, for the voxel VC3 to a voxel VC5 that are present in the identical processing block BL1, the WALK processing similarly continues. That is, the voxels VC3 to VC5 are each sequentially set as a focusing-on voxel, and the first processing and the second processing are repeatedly executed. As a result, the ray R moves to the voxel VC5. That is, the voxel VC5 is set as a focusing-on voxel.

In the WALK processing on the focusing-on processing voxel VC5, the ray R advances in the direction along the axis Y in the first processing. In the second processing, since an adjacent voxel VC6 belongs to the processing block BL2 that is different from that to which the focusing-on voxel VC5 belongs, a transition of processing occurs from the WALK processing to the processing in the RT core (hardware processing). Then, since the ray R is allowed to extend from a side, in the direction along the axis Y, of the voxel VC5 in the processing block BL1 under the processing in the RT core, the adjacent processing block BL2 serves as a destination to which the ray R is allowed to extend. The processing block BL2 is a region in which a part of the target T may be present. That is, since the ray R collies with the processing block BL2, a transition of processing occurs again from the processing in the RT core (hardware processing) to the WALK processing (software processing). The trajectory drawn under the processing in the RT core, in which the ray R is allowed to extend from the processing block BL1 after the WALK processing ends to the adjacent processing block BL2, as described above, corresponds to the RT-core-processing trajectory RB11.

Similarly, the trajectory drawn under the processing in the RT core, in which the ray R is allowed to extend from the processing block BL2 after the WALK processing ends to the adjacent processing block BL3, corresponds to the RT-core-processing trajectory RB12. The trajectory drawn under the processing in the RT core, in which the ray R is allowed to extend from the processing block BL3 after the WALK processing ends to the adjacent processing block BL4, corresponds to the RT-core-processing trajectory RB13. The trajectory drawn under the processing in the RT core, in which the ray R is allowed to extend from the processing block BL5 after the WALK processing ends to the adjacent processing block BL6, correspond to the RT-core-processing trajectory RB14. The trajectory drawn under the processing in the RT core, in which the ray R is allowed to extend from the processing block BL6 after the WALK processing ends to the adjacent processing block BL7, corresponds to the RT-core-processing trajectory RB15.

In the conventional processing of ray tracing illustrated in FIG. 3, as described above, when, in a processing block BL, a voxel VC that is adjacent to a focusing-on voxel VC belongs to the identical processing block BL, the WALK processing that is software processing continues. When a voxel VC adjacent to a focusing-on voxel VC belongs to a different block (regardless of whether or not the block is a pass-through block BLK or a processing block BL), on the other hand, a transition of processing occurs from the WALK processing to the processing in the RT core, which is hardware processing. Then, skipping occurs, when a pass-through block BLK is present, under the processing in the RT core, and processing of allowing the ray R to extend (move) to a next processing block is executed.

When one or more pass-through blocks BLK are present, as illustrated by the RT-core-processing trajectories RK11 to RK13, even in the conventional ray tracing, processing of skipping the one or more pass-through blocks BLK also occurs in the processing in the RT core, contributing to improved, efficient (prompt) processing of generating an output image SG.

However, even when a transition occurs from the WALK processing to the processing in the RT core when a pass-through block BLK is not present, as illustrated by the RT-core-processing trajectories RB11 to RB15 described above, processing of skipping does not occur, and the WALK processing is resumed again. The inventors have found that this fact further wastes extra time in the processing of generating an output image SG, leading to a factor of worsened, low efficient (slowed) processing of generating an output image SG. Therefore, the inventors have reached a new method of removing the factor of worsened, low efficient (slowed) processing of generating an output image SG in the conventional ray tracing. That is, the inventors have found that preventing the processing in the RT core, which is indicated by the RT-core-processing trajectories RB11 to RB15, (preventing an unnecessary transition from the WALK processing to the processing in the RT core) from occurring has shortened a period of time taken for the processing of ray tracing, and the inventors have thus reached a new method for further improved, efficient (prompt) processing of generating an output image SG.

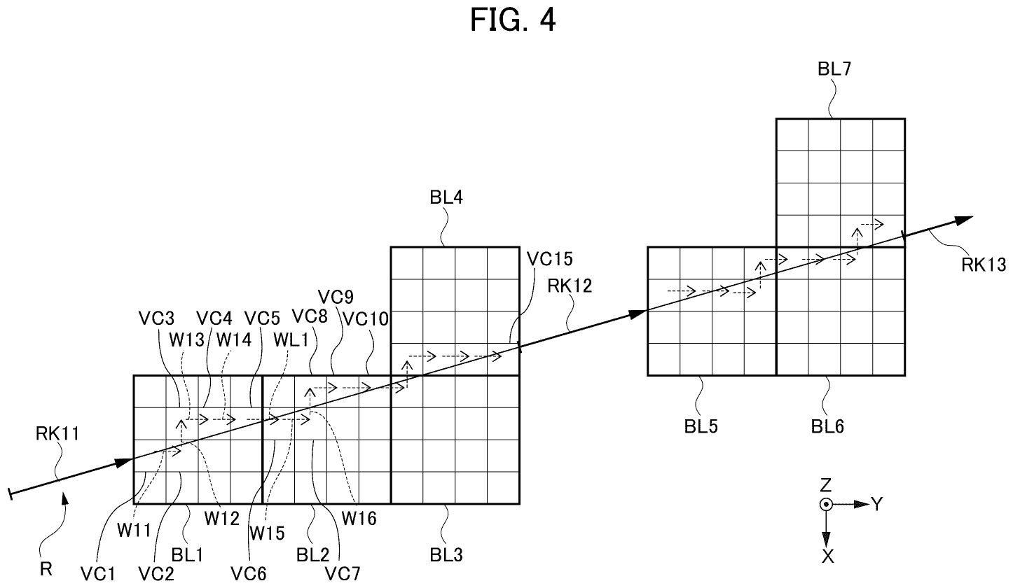

Therefore, ray tracing using this new method, that is, ray tracing applied to the rendering device in the present service illustrated in FIG. 1 will now be described with reference to FIG. 4. FIG. 4 is a view illustrating an outline of the processing of ray tracing applied to the rendering device in the present service illustrated in FIG. 1.

FIG. 4 does not illustrate the RT-core-processing trajectories RB11 to RB15 illustrated in FIG. 3. That is, the rendering device in the present service allows the WALK processing to continue, without allowing such an unnecessary transition from the WALK processing (software processing) to the processing in the RT core (hardware processing) as indicated by the RT-core-processing trajectories RB11 to RB15 illustrated in FIG. 3 between adjacent processing blocks BL. Thereby, shortening a period of time taken for the processing of ray tracing than that taken conventionally, as illustrated in FIG. 3, as a result makes it possible to lead to improved, efficient processing of generating an output image SG, that is, to shorten a period of time taken for generating an output image SG.

That is, as preliminary processing for ray tracing, the rendering device in the present service generates, as link information, information relating to an adjacent processing block per processing block BL. Note herein that the term “adjacent” means that ones are adjacent to each other in not only directions along an x axis and a y axis, but also a direction along a z axis. That is, link information is information indicating which another adjacent processing block is, when viewed from a predetermined processing block BL. The link information is linked to the predetermined processing block BL.

Specifically, for example, link information “the processing block BL2 is adjacent in a positive direction along the axis Y” is generated for the processing block BL1. Then, the link information is linked to the processing block BL1. Furthermore, for example, link information “the processing block BL1 is adjacent in a negative direction along the axis Y” is generated for the processing block BL2. Furthermore, link information “the processing block BL3 is adjacent in the positive direction along the axis Y” is generated for the processing block BL2. Then, these pieces of the link information are linked to the processing block BL2. As described above, pieces of link information are generated for each of the processing blocks BL1 to BL7.

When a ray R enters a processing block BL while the processing in the RT core (hardware processing) is executed, as illustrated in FIG. 4, switching to the WALK processing (software processing) (a transition of processing) occurs. Specifically, for example, when the processing in the RT core is executed and the ray R advancing along the RT-core-processing trajectory RK11 illustrated in FIG. 4 enters the processing block BL1, switching of processing to the WALK processing occurs. Then, since adjacent voxels VC to the voxels VC1 to VC4 in the processing block BL1 all belong to the identical processing block BL1, the voxels VC1 to VC4 are each sequentially set as a focusing-on voxel VC, and the WALK processing is continuously executed. As a result, the ray R advances to the voxel VC5, and the voxel VC5 is set as a focusing-on voxel VC. An adjacent voxel VC to the focusing-on voxel VC5 in the processing block BL1 belongs to the different processing block BL2.

Therefore, in the conventional ray tracing illustrated in FIG. 3, an unnecessary transition from the WALK processing to the processing in the RT core has occurred. On the other hand, the ray tracing executed by the rendering device in the present service is different from the conventional ray tracing illustrated in FIG. 3 in those described below.

That is, a different point from the conventional ray tracing is that, when a ray R enters an adjacent processing block BL while the WALK processing by software processing is executed, switching to the processing in the RT core is prohibited, and the WALK processing (software processing) continues. Specifically, for example, in the WALK processing on the focusing-on voxel VC5 in the processing block BL1, first processing of judging the voxel VC6 that is adjacent in the advancing direction of the ray R, when viewed from the focusing-on voxel VC5, as the adjacent voxel VC6 is executed as first processing. Next, second processing of determining whether or not the adjacent voxel VC6 (the adjacent voxel VC6 that is adjacent to the focusing-on voxel VC5 in the first processing) as a result of the first processing is a voxel VC in the processing block BL1 is executed. Then, it is determined that the adjacent voxel VC6 as a result of the second processing does not belong to the identical processing block BL1. Furthermore, the link information is used, and it is determined that the adjacent processing block BL2 is present in a direction in which the adjacent voxel VC6 is adjacent, that is, in the direction along the axis Y, when viewed from the focusing-on voxel VC5. In other words, it is determined that the block BL2 that is adjacent in the direction along the axis Y, when viewed from the processing block BL1, is not a pass-through block BLK, but a processing block BL. That is, it is determined that the ray R enters, from the processing block BL1, the processing block BL2 that is adjacent to the processing block BL1. Therefore, in the ray tracing executed by the rendering device in the present service, processing of prohibiting switching to the processing in the RT core from occurring, but of allowing the WALK processing to continue is further executed as the second processing. That is, unnecessary processing such as the processing in the RT core is not executed, the voxel VC6 in the adjacent processing block BL2 is immediately set as a focusing-on voxel VC, and the WALK processing is continuously executed in the processing block BL2.

After that, when the ray R enters a pass-through block BLK while the WALK processing by software processing is continuing, switching (a transition) of processing to the processing in the RT core occurs. Specifically, for example, since adjacent voxels VC7 to VC10 to the focusing-on voxels VC6 to VC9 in the processing block BL2 all belong to the identical processing block BL2, respectively, the voxels VC7 to VC10 are each sequentially set as a focusing-on voxel VC, and the WALK processing is continuously executed.

Then, unnecessary processing such as the processing in the RT core is not executed even between the processing block BL2 and the processing block BL3 adjacent to each other, a voxel VC in the adjacent processing block BL3 is immediately set as a focusing-on voxel VC, and the WALK processing is continuously executed in the processing block BL3. Furthermore, unnecessary processing such as the processing in the RT core is not executed even between the processing block BL3 and the processing block BL4 adjacent to each other, a voxel VC in the adjacent processing block BL4 is immediately set as a focusing-on voxel VC, and the WALK processing is continuously executed in the processing block BL4.

Then, in the processing block BL4, a voxel VC15 is set as a focusing-on voxel VC. In the WALK processing in the focusing-on voxel VC15, first processing of judging a non-illustrated voxel VC that is adjacent in the advancing direction of the ray R, when viewed from the focusing-on voxel VC15, as an adjacent voxel VC is executed as first processing. Next, second processing of determining whether or not the adjacent voxel VC as a result of the first processing (the non-illustrated adjacent voxel VC that is adjacent in the advancing direction of the ray R, when viewed from the focusing-on voxel VC15, in the first processing) is a voxel VC in the processing block BL4 is executed. That is, as the second processing, it is determined that the adjacent voxel VC belongs to a non-illustrated block BL that is different from the processing block BL4. Furthermore, the link information is used, and it is determined that the adjacent block BL is a pass-through block BLK. That is, it is determined that the ray R enters, from the processing block BL4, the pass-through block BLK that is adjacent to the processing block BL4. Therefore, in the ray tracing executed by the rendering device in the present service, processing of switching from the WALK processing to the processing in the RT core is further executed as the second processing.

As described above, the rendering device in the present service makes it possible to identify, based on link information, whether or not an adjacent voxel VC that is a candidate that may be next set as a focusing-on voxel VC belongs to a pass-through block BLK or a processing block BL. Then, the rendering device in the present service makes it possible, when it is identified that there is a collision with a different processing block BL to which the adjacent voxel VC belongs while the WALK processing is executed in the processing block BL, to allow the WALK processing to continue, without allowing a transition to the processing in the RT core to occur, differently from those conventionally performed. Thereby, in the rendering device in the present service, as illustrated in FIG. 4, the processing in the RT core, which has been necessary in the conventional ray tracing, and which corresponds to the RT-core-processing trajectories RB11 to RB15 illustrated in FIG. 3, is not executed. As a result, it is possible to shorten a period of time taken for processing on the RT-core-processing trajectories RB11 to RB15.

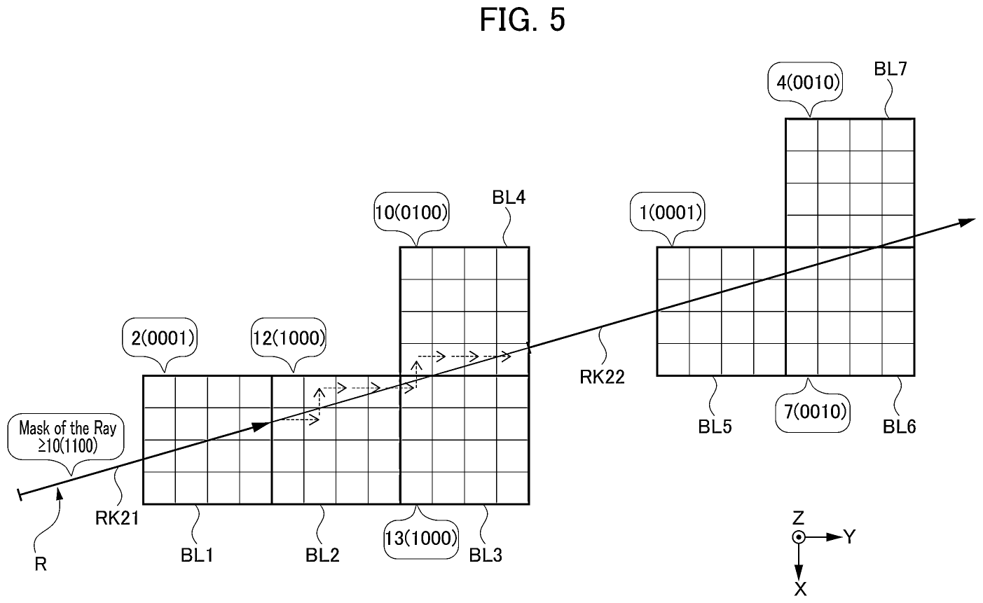

Next, an outline of a mask for achieving further efficient ray tracing executed by the rendering device in the present service will now be described with reference to FIG. 5. A mask refers to processing to be executed, when an output image SG satisfying a predetermined purpose is to be generated, for not regarding all processing blocks BL as those that are subject to the WALK processing, but regarding, as a mask block, a processing block BL including only a voxel VC outside the predetermined purpose (hereinafter referred to as an “outside-purpose voxel VC”), and for excluding the mask block from those that are subject to the WALK processing. FIG. 5 is a view illustrating an outline of a mask for achieving further efficient ray tracing executed by the rendering device in the present service illustrated in FIG. 1.

Note herein that, as a prerequisite, an example of determining a pixel value of a predetermined pixel in an output image SG in volume rendering will now be described. An output image SG generated through volume rendering is used to grasp an internal structure of a target T. That is, a prerequisite is that the target T internally has a structure. As the target T in the present service illustrated in FIG. 1, a mineral is exemplified. In a mineral, its density is not uniform, and the density may be partially different in many cases. Therefore, it will be described herein that, in the target T, its density is not uniform, but the density is partially different. Furthermore, performing image analysis, for example, for each slice SLk makes it possible to achieve grasping of the distribution of density in the target T. That is, a part of the target T is included in a processing block BL in a slice SLk of the target T. Therefore, performing image analysis, for example, makes it possible to achieve grasping of the density in each part of the target T, in each of the 4×4 voxels VC forming the processing block BL, which include the parts of the target T, respectively. Then, changing a pixel value of a predetermined pixel in accordance with the density in the part of the target T (in the processing block BL in the slice Slk), which is present on a straight line starting from the predetermined point of view VP and passing through the predetermined pixel in an output image SG makes it possible to acquire the output image SG from which it is possible to grasp an internal structure.

Note herein that, for example, there may be a desired purpose of grasping how a part, in which its density is equal to or more than a predetermined value, of the target T is three dimensionally formed. In this case, it is conceivable that a part in which the density is below the predetermined value, among parts (for example, a predetermined substance) that form the target T is outside the purpose. To prevent such a part outside the purpose from being reflected on an output image SG, it is enough to implement processing of excluding a voxel VC including the part outside the purpose (in this example, a part in which the density is below the predetermined value), as an outside-purpose voxel VC, from those that are subject to the WALK processing. However, performing processing in a unit of voxel VC is less efficient. Therefore, to efficiently achieve such processing, a processing block BL is regarded as a unit of processing, and processing of identifying, as a mask block, a processing block BL including only an outside-purpose voxel VC, and of excluding the mask block from those that are subject to the WALK processing is implemented. This processing is an example of the mask.

Furthermore, for example, volume rendering is also used to grasp how a predetermined substance is disposed in the target T. That is, there may be a desired purpose of generating an output image SG only based on a voxel VC with predetermined density among the density in a plurality of voxels VC, respectively. In this case, substances having values of the density other than the predetermined value are outside the purpose. That is, a voxel VC including a part of a substance that is outside the purpose, where the density having a value other than the predetermined value is linked, is regarded as an outside-purpose voxel VC. To prevent such a substance that is outside the purpose from being reflected on an output image SG, processing of identifying, as a mask block, a processing block BL including the substance that is outside the purpose (in this example, an outside-purpose voxel VC with which the density having a value other than the predetermined value is associated), and of excluding the mask block from those that are subject to the WALK processing is implemented. Such processing is another example of the mask.

As described above, as the mask used in the rendering device in the present service, it is possible to identify, as a mask block, a processing block BL including only an outside-purpose voxel VC, and it is possible to execute the mask as control of prohibiting execution of the WALK processing for the mask block. Using the mask as described above makes it possible to exclude, as a mask block, a processing block BL that is outside the purpose from those that are subject to the WALK processing, making it possible to achieve further prompt volume rendering. The mask will now be further described herein in detail.

The mask functions based on mask parameters including a first parameter set for each processing block BL and a second parameter set for a ray R. The mask parameters, that is, the first parameter and the second parameter will now be described herein.

In the mask, a representative value among those of voxels VC included in a processing block BL and its bit string are set as the first parameter in the processing block BL. The representative value is, among values of density, which are linked to an n-number of voxels VC included in a processing block BL, a value of density in a voxel representing the processing block BL. The bit string is a string of a plurality of bits applied, based on a predetermined rule, to the representative value. In the example illustrated in FIG. 5, a representative value among those of the voxels VC included in each of the processing blocks BL1 to BL7 and its bit string (indicated in a balloon in the figure) are set for each of the processing blocks BL1 to BL7. Specifically, for example, 2 is set as a representative value, and “0001” is set as a bit string corresponding to the representative value for the processing block BL1. Similar to those illustrated in FIG. 5, such a representative value and a bit string corresponding to the representative value will be described by indicating it as “representative value (bit string)”. For the processing block BL1, as an example, “2(0001)” is indicated and described.

Furthermore, on the premise of the first parameter for the processing block BL, the second parameter is a parameter for recognizing whether or not the processing block BL serves as a mask block. As will be described later in detail, a logical multiplication of the bit string of the first parameter and the bit string of the second parameter, which are set for the processing block BL, is calculated per bit, and, when results of calculation of all bits are false, the processing block BL is recognized as a mask block, and the WALK processing is skipped.

A specific example of the first parameter will now be described herein. Note that it will be described herein that processing of excluding a processing block BL that does not include a voxel VC in which the density is equal to or more than 10, that is, a processing block BL having a representative value below 10, among processing blocks BL, from those that are subject to the WALK processing is to be executed.

A maximum value of the density among those of the density in voxels VC forming a processing block BL is first adopted as a representative value for the processing block BL. Then, its bit string is to be generated based on a predetermined rule described below. That is, for example, when a range within which a representative value falls starts from 0 to 15, and a four-digit bit string is adopted as a bit string, and when a representative value ranges from 0 to 3, “0001” is associated as a bit string, when a representative value ranges from 4 to 7, “0010” is associated as a bit string, when a representative value ranges from 8 to 11, “0100” is associated as a bit string, and when a representative value ranges from 12 to 15, “1000” is associated as a bit string. A representative value and its bit string associated with each other as described above are set as the first parameter.

Next, a specific example of the second parameter will now be described herein. For example, the second parameter (a bit string) for a ray R is set with a logical sum of the bit string of the first parameter for a processing block BL desired to be reflected on an output image SG. Specifically, for example, “10(1100)” that is a logical sum of the bit string when the representative value equal to or more than 10 is adopted as the first parameter for the processing block BL described above is set as the second parameter for the ray R. Note that, in FIG. 5, the “density equal to or more than 10” is shown as “≥10”.

Then, in the processing in the RT core (hardware processing), the RT core allows a ray R to extend in such a manner that a processing block BL that does not satisfy a condition that is set based on the first parameter for the processing block BL and the second parameter for the ray R is ignored. Note that such a condition will be hereinafter referred to as a “mask processing condition”.

Specifically, for example, the rendering device in the present service once regards all processing blocks BL as candidates, and sets, as a mask condition, a condition that at least one logical multiplication of each of the bits in the first parameter for each of the candidate processing blocks BL and each of the bits in the second parameter for the ray R includes a bit indicating true. Note herein that a mask condition is a condition for determining whether or not a block is a mask block. A candidate that does not satisfy the mask condition is identified as a mask block in here. As a result, the rendering device in the present service identifies a block that does not satisfy the mask condition, among the candidate processing blocks BL, as a mask block (excludes the block from the candidates), regards the mask block as if the mask block is not a processing block BL, but is a pass-through block BLK, and does not allow the ray R to collide with the block, but allows the ray R to pass through the block (that is, excludes the block from those that are subject to the WALK processing). Then, the rendering device in the present service regards only a candidate satisfying the mask condition as a processing block BL, and allows the ray R to collide with the block, and then allows a transition to the WALK processing to occur. In other words, only when the ray R collies with a processing block BL satisfying the mask condition, a transition of processing to the WALK processing occurs.

Specifically, for example, in sections indicated by RT-core-processing trajectories RK21 and RK22 in the example shown in FIG. 5, the first parameter for the processing block BL1 is “0010”, the first parameter for the processing block BL5 is “0001”, the first parameter for the processing block BL6 is “0010”, and the first parameter for the processing block BL7 is “0010”. Therefore, in the processing in the RT core, the processing block BL1 and the processing blocks BL5 to BL7 are identified as mask blocks, through which the ray R passes, and are excluded from those that are subject to the WALK processing. As a result, software-processing trajectories (dotted-line arrows) under the WALK processing (software processing) in the example shown in FIG. 5 are reduced in number, compared with those in the example shown in FIG. 4. This result corresponds to a shortened extra time in the processing of generating an output image SG.

Note that the first parameter is, as described above, a representative value of the density among those in voxels VC forming a processing block BL. Therefore, it is conceivable that the processing block BL4 having the first parameter equal to or more than 10 is subject to the WALK processing, but may include a voxel VC in which the density is below 10. Therefore, in the WALK processing, such a pixel value is calculated that prevents a voxel VC in which the density is below 10 from being reflected on a predetermined pixel in an output image SG.

Furthermore, as described above, when the first parameter ranges from 8 to 11 in the example shown in FIG. 5, “0100” is adopted as its bit string. Therefore, even if a processing block BL having the first parameter of “9(0100)” is present, it is impossible to distinguish the block from a processing block BL having the first parameter of “10(0100)” in the processing in the RT core. Therefore, as to the first parameter, similar to a voxel VC in which the density is below 10 in the processing block BL4 described above, the WALK processing is also executed in the processing block BL having the first parameter of “9(0100)”, and, for each of all the voxels VC in the processing block BL, a pixel value is calculated in such a manner that the calculated pixel value is prevented from being reflected on a predetermined pixel in an output image SG.

That is, a meaning of the mask is to use the processing in the RT core (hardware processing) to achieve prompt execution for a processing block BL including only voxels VC that are not securely reflected on predetermined pixels in an output image SG, among a plurality of processing blocks BL. That is, the first parameter is used to manage a processing block BL, and the first parameter and the second parameter for a ray R are used to execute processing, acquiring an effect of shortening extra time in the processing of generating an output image SG.

Note that, although the mask has been applied, in the example described above, when judging whether or not a transition from the processing in the RT core to the WALK processing is allowed, it is possible to apply the mask in an opposite transition, that is, when judging whether or not a transition from the WALK processing to the processing in the RT core is allowed.

Specifically, for example, it is assumed in here that the WALK processing is executed in a processing block BL having the first parameter of “10(0100)”, and an adjacent processing block BL is present. However, the adjacent processing block BL only includes voxels VC in which the density is below 10. Specifically, for example, it is assumed in here that the adjacent processing block BL is linked with the first parameter of “7(0010)”. Then, it is assumed in here that, in the WALK processing, a focusing-on voxel VC is present at an edge between the processing block BL having the first parameter of “10(0100)” and the adjacent processing block BL. That is, it is assumed in here that the adjacent voxel VC to the focusing-on voxel VC belongs to the adjacent processing block BL linked with the first parameter of “7(0010)”.

In this case, as described above, the link information is used, and it is determined that a block that is adjacent in a direction in which the adjacent voxel VC is adjacent, when viewed from the focusing-on voxel VC, that is, in the direction along the axis Y is a processing block BL. However, since the processing block BL to which the adjacent voxel VC belongs is linked with the first parameter of “7(0010)” (the density below 10), the mask condition is not satisfied. Therefore, when it is determined that, while the WALK processing is executed, a processing block BL to which an adjacent voxel VC belongs does not satisfy the mask condition, a rendering device 1 identifies the processing block BL as a mask block, and prohibits execution of the WALK processing. Note herein that, as processing of prohibiting execution of the WALK processing, processing of skipping the WALK processing for a processing block BL to which the adjacent voxel VC belongs (which is regarded as software processing) may be adopted, and processing of allowing the WALK processing to end and allowing a transition to the processing in the RT core (hardware processing) to occur may be adopted. Thereby, even while the WALK processing is executed, such an effect of shortening extra time is acquired in the processing of generating an output image SG.

Note that, in the description with reference to FIGS. 3 to 5, the directions along the axis X and the axis Y have been adopted for describing those adjacent to a processing block BL or a voxel VC. However, crossing of a straight line starting from the predetermined point of view VP and passing through a predetermined pixel in an output image SG occurs in the direction along the axis Z at a predetermined angle. That is, processing in an RT core 12H, where there is a predetermined angle with respect to a line extending in the direction along the axis Z (ray tracing by hardware processing) and WALK processing in a CU 12S (ray tracing by software processing) are executed. Therefore, link information relating to the direction along the axis Z is also generated. Then, similar to the description about the directions along the axis X and the axis Y described above, a processing block BL or a voxel VC adjacent in the direction along the axis Z is taken into account to execute ray tracing processing.

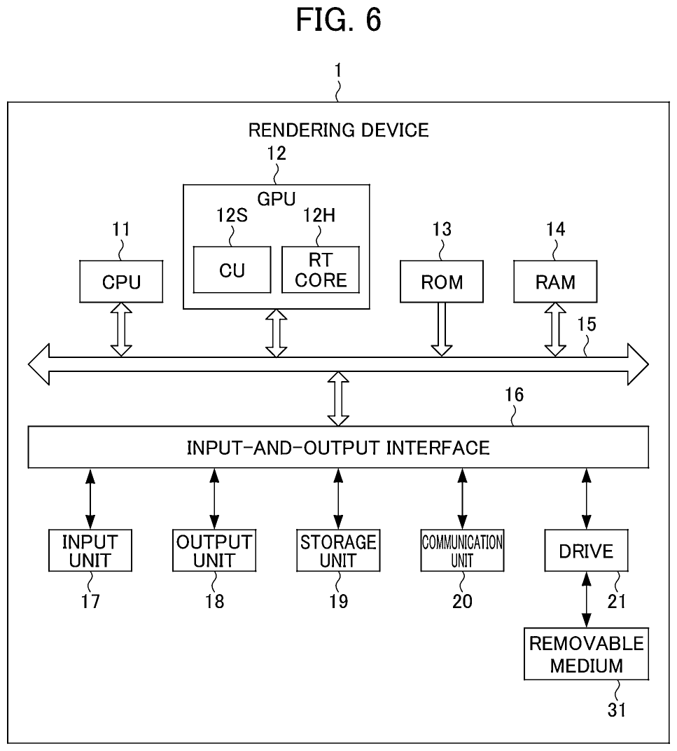

The present service has been described above with reference to FIGS. 1 to 5. The rendering device to which the present service is applied will now be described herein with reference to FIGS. 6 to 8.

FIG. 6 is a block diagram illustrating an example of a hardware configuration of the rendering device applied in the present service described with reference to FIGS. 1 to 5, that is, the rendering device relating to the embodiment of the information processing device according to the present invention. The rendering device 1 includes a central processing unit (CPU) 11, a graphics processing unit (GPU) 12, a read-only memory (ROM) 13, a random access memory (RAM) 14, a bus 15, an input-and-output interface 16, an output unit 17, an input unit 18, a storage unit 19, a communication unit 20, and a drive 21.

The CPU 11 and the GPU 12 execute various types of processing in accordance with programs recorded in the ROM 13 or programs loaded from the storage unit 19 to the RAM 14. The GPU 12 includes a computing unit that executes software processing (hereinafter described as the “CU 12S” in a simplified manner) and the RT core 12H that executes hardware processing. The RT core 12H executes, in a hardware manner, ray tracing on a predetermined three-dimensional space in which a target is included. The RAM 14 appropriately stores, for example, data necessary for the CPU 11 and the GPU 12 when executing various types of processing.

The CPU 11, the GPU 12, the ROM 13, and the RAM 14 are coupled to each other via the bus 15. The bus 15 is further coupled to the input-and-output interface 16. The input-and-output interface 16 is coupled to the output unit 17, the input unit 18, the storage unit 19, the communication unit 20, and the drive 21.

The output unit 17 includes a display and a loud-speaker to output various types of information in the form of image and audio, for example. The input unit 18 includes a keyboard and a mouse to accept various types of information, for example.

The storage unit 19 includes a hard disk and a dynamic random access memory (DRAM) to store various types of data, for example. The communication unit 20 performs communications with other devices via a network including the Internet.

The drive 21 is appropriately attached with a removable medium 31 such as a magnetic disk, an optical disk, a magnetic optical disk, or a semiconductor memory. A program read from the removable medium 31 by the drive 21 is installed into the storage unit 19 as required. Furthermore, the removable medium 31 is able to store various types of data stored in the storage unit 19, similar to the storage unit 19.

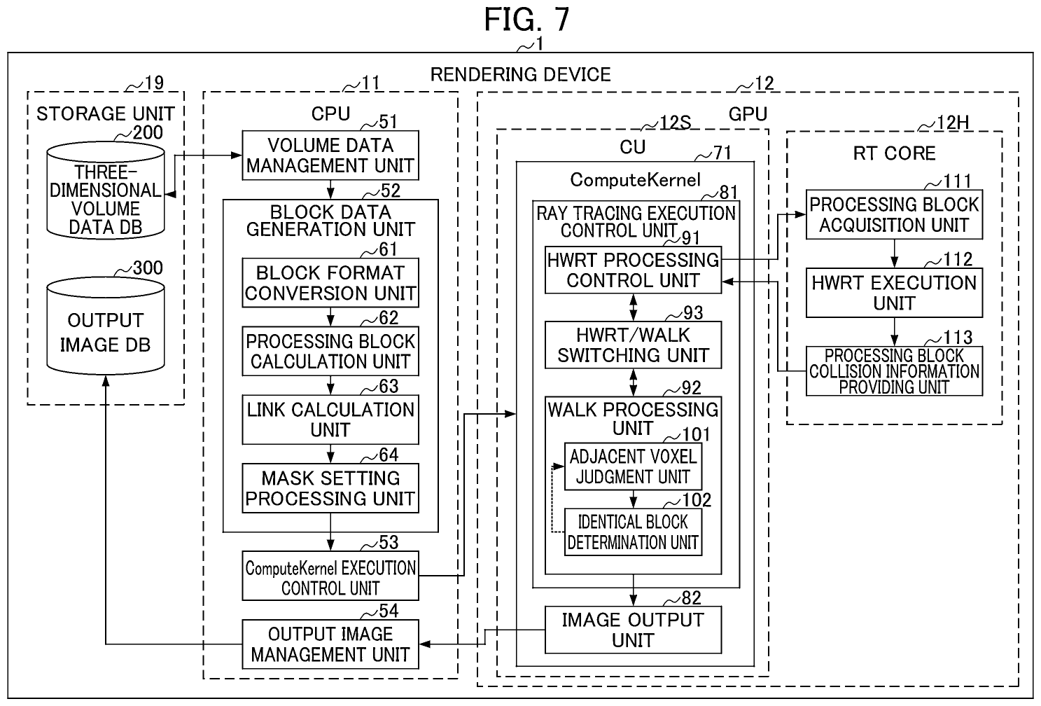

Next, a functional configuration of the rendering device 1 having the hardware configuration illustrated in FIG. 6 will now be described with reference to FIG. 7. FIG. 7 is a functional block diagram illustrating an example of the functional configuration of the rendering device illustrated in FIG. 6.

In the CPU 11 in the rendering device 1, as illustrated in FIG. 6, a volume data management unit 51, a block data generation unit 52, a ComputeKernel execution control unit 53, and an output image management unit 54 function. In the CU 12S in the GPU 12 in the rendering device 1, a ComputeKernel 71 functions. In the RT core 12H in the GPU 12 in the rendering device 1, a processing block acquisition unit 111, an HWRT execution unit 112, and a processing block collision information providing unit 113 function. In regions of the storage unit 19 in the rendering device 1, a three-dimensional volume data DB 200 and an output image DB 300 are provided.

In the three-dimensional volume data DB 200, three-dimensional volume data VD is stored beforehand.

The volume data management unit 51 manages the three-dimensional volume data VD stored in the three-dimensional volume data DB 200. Specifically, for example, the volume data management unit 51 reads the three-dimensional volume data VD relating to the target T that is subject to volume rendering processing.

The block data generation unit 52 executes preliminary processing of conversion into information of processing blocks BL and voxels VC, based on the three-dimensional volume data VD. Specifically, the block data generation unit 52 includes a block format conversion unit 61, a processing block calculation unit 62, a link calculation unit 63, and a mask setting processing unit 64.

The block format conversion unit 61 calculates, based on a slice SLk included in the three-dimensional volume data VD, density in each of voxels VC included in the slice SLk. Then, the block format conversion unit 61 converts a format of the slice SLk into a block format. The block format refers to a format where an n-number of the voxels VC are regarded as a block, and the slice SLk is divided into the blocks.

The processing block calculation unit 62 regards, among a plurality of the blocks forming the slice SLk in which a region corresponding to a part of the target T (an object of the part) may be included, as processing blocks BL and others of the blocks as pass-through blocks BLK. The processing block calculation unit 62 regards the processing blocks BL as candidates that are subject to collision determination in the processing in the RT core (hardware processing).

The link calculation unit 63 calculates, as link information, information of other ones of the processing blocks BL adjacent to one of the processing blocks BL. The link information of the other ones of the processing blocks BL is linked to the one of the processing blocks BL.

The mask setting processing unit 64 executes, based on the density in each of the n-number of voxels VC included in the processing block BL, processing of regarding the density in one of the voxels, which represents the processing block BL, as a representative value, and of setting the first parameter. Furthermore, the mask setting processing unit 64 executes, based on the first parameter, processing of setting, for a ray R, the second parameter for determining a mask condition.

The ComputeKernel execution control unit 53 performs, based on a result of the preliminary processing by the block data generation unit 52, control of causing the CU 71 in the GPU to execute processing relating to the ComputeKernel 71.

The ComputeKernel 71 includes a ray tracing execution control unit 81 and an image output unit 82. The ray tracing execution control unit 81 includes an HWRT processing control unit 91, a WALK processing unit 92, and an HWRT/WALK switching unit 93.

The HWRT processing control unit 91 performs, as ray tracing by hardware processing, control of causing the processing in the RT core 12H to be executed as HWRT. The WALK processing unit 92 executes, as ray tracing by software processing, the WALK processing in the CU 12S.

When the HWRT processing control unit 91 functions, a main processing entity transitions to the processing block acquisition unit 111 in the RT core 12H. The processing block acquisition unit 111 acquires the information of the processing blocks BL. Furthermore, the processing block acquisition unit 111 acquires the first parameter set for each of the processing blocks BL as information used for the mask. The information used for the mask is linked to the information of the processing blocks BL.

In the RT core 12H, the HWRT execution unit 112 allows a ray R to extend in a pseudo manner toward a virtual three-dimensional space in which the acquired processing blocks BL are disposed to execute HWRT for calculating a position in the three-dimensional space, at which a collision of the ray R occurs. At this time, the HWRT execution unit 112 regards, based on the first parameter, one or more of the processing blocks BL, which do not satisfy the mask condition (in the example illustrated in FIG. 5, the processing blocks BL1 and BL5 to BL7, for example), as if the blocks are not processing blocks but are pass-through blocks BLK, and does not allow a collision to occur, but allows the ray R to pass through the blocks. As a result, the position in the three-dimensional space, at which a collision of the ray R occurs, in the HWRT execution unit 112 is a nodal point of one of the processing blocks BL, which has satisfied the mask condition (in the example illustrated in FIG. 5, the processing block BL2), and the ray R.

The processing block collision information providing unit 113 provides, to the HWRT processing control unit 91, information of the position in the three-dimensional space, at which the ray R has collided with the one of the processing blocks BL. The HWRT processing control unit 91 acquires, based on the information of the position in the three-dimensional space, at which the ray R has collided with the one of the processing blocks BL, which has been provided from the processing block collision information providing unit 113, information from which it is possible to identify the one of the processing blocks BL, with which the ray R has collided. Processing in which the processing block acquisition unit 111, the HWRT execution unit 112, and the processing block collision information providing unit 113 function, as described above, corresponds to the processing in the RT core (hardware processing) described above.

When the ray R enters one of the processing blocks BL while the processing in the RT core 12H (hardware processing) is executed, the HWRT/WALK switching unit 93 performs switching to the ray tracing by the WALK processing (software processing). That is, the HWRT/WALK switching unit 93 causes the WALK processing unit 92 to function.

When the HWRT/WALK switching unit 93 has caused the WALK processing unit 92 to function, the processing transitions to the WALK processing in the CU 12S. The WALK processing unit 92 includes an adjacent voxel judgment unit 101 and an identical block determination unit 102.

The adjacent voxel judgment unit 101 judges, as the first processing, a voxel VC that is adjacent in the advancing direction of the ray R, when viewed from a focusing-on voxel VC. That is, the adjacent voxel judgment unit 101 judges, as an adjacent voxel VC, a voxel VC, in which a straight line of the ray R along which the RT-core-processing trajectories RK11 and RK12 run crosses, when viewed from the focusing-on voxel VC in the processing block BL.

Note that, when the adjacent voxel judgment unit 101 functions as a result of the control by the HWRT processing control unit 91, a voxel VC, which lies on a straight line of the ray R, which starts from the predetermined point of view VP and passes through a predetermined pixel in an output image SG, in the processing block BL with which the ray R has collided, which has been acquired as a result of the processing in the RT core 12H, is set as a focusing-on voxel VC. Then, an adjacent voxel VC is judged from the focusing-on voxel.

Furthermore, when the adjacent voxel judgment unit 101 functions as a result of control by the identical block determination unit 102, which will be described later, the adjacent voxel VC is set as a focusing-on voxel VC. Then, an adjacent voxel VC is judged from the focusing-on voxel.

The identical block determination unit 102 determines, as the second processing, whether or not the adjacent voxel VC is present in the identical processing block BL to which the focusing-on voxel VC belongs. When the determination by the identical block determination unit 102 is true, the adjacent voxel judgment unit 101 functions again. Thereby, while the determination by the identical block determination unit 102 is true, the adjacent voxel judgment unit 101 and the identical block determination unit 102 function repeatedly. Thereby, the WALK processing (software processing) continues in the identical processing block BL. When the determination by the identical block determination unit 102 is false, control of performing switching of the processing by the HWRT/WALK switching unit 93 is performed.

The HWRT/WALK switching unit 93 performs switching of processing depending on whether or not a block next to the processing block BL, into which the ray R enters, is a pass-through block BLK or a processing block BL, while the ray tracing by the WALK processing (software processing) is executed. Specifically, when the ray R enters a pass-through block BLK while the ray tracing by the WALK processing (software processing) is executed, the HWRT/WALK switching unit 93 performs switching to the ray tracing by the RT core 12H. That is, the processing in the RT core 12H (hardware processing) is executed by the HWRT processing control unit 91. Furthermore, when the ray R enters an adjacent processing block BL, the HWRT/WALK switching unit 93 prohibits switching to the ray tracing by the RT core unit. That is, the HWRT/WALK switching unit 93 allows that the WALK processing unit 92 is functioning continuously.

That is, the HWRT/WALK switching unit 93 uses the link information linked to a processing block BL before the ray R moves to determine whether or not the block to which the ray R is about to move is an adjacent processing block BL. Based on the determination, the HWRT/WALK switching unit 93 performs switching between the hardware ray tracing and the WALK processing. Thereby, as a result that the HWRT/WALK switching unit 93 has functioned, prohibition of an unnecessary transition from the WALK processing to the processing in the RT core is achieved. As a result, a period of time taken for the processing of ray tracing is shortened, leading to improved, efficient processing of generating an output image SG.

The ComputeKernel 71 sequentially sets each of pixels forming an output image SG as a focusing-on pixel, and executes processing of ray tracing for determining a pixel value of the focusing-on pixel simultaneously, parallelly, and repeatedly. That is, the ComputeKernel 71 causes the functions described above to be exerted parallelly for each of the plurality of pixels forming the output image SG to determine pixel values of all the pixels forming the output image SG.

The image output unit 82 outputs the output image SG for which the pixel values of all the pixels have been determined. The output image management unit 54 manages and stores the output image SG in the output image DB 300.

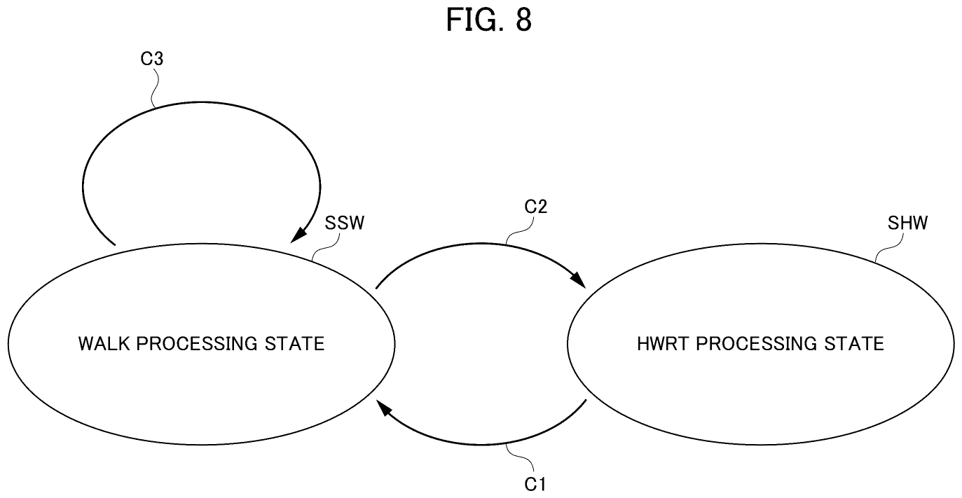

The functional configuration of the rendering device 1 has been described above with reference to FIG. 7. A state transition between a state of the processing in the RT core 12H (hardware processing) and a state of the processing in the CU 12S (software processing) in the rendering device 1 will now be described herein with reference to FIG. 8.

FIG. 8 is a state transition diagram illustrating an example of state transitions in the rendering device having the functional configuration illustrated in FIG. 7. In FIG. 8, the states are each indicated as one ellipse, and are distinguished from each other by symbols including the letter “S”, which is provided to the ellipses. A state transition from one state to another one state is executed when a predetermined condition (hereinafter referred to as a “state transition condition”) is satisfied. Such a state transition condition as described above is illustrated, in FIG. 8, by an arrow representing a transition from one state to another one state with a symbol including the letter “C” applied.

An HWRT processing state SHW is a state where the HWRT processing control unit 91 is functioning, and a state where the processing in the RT core 12H described above is executed. In the HWRT processing state SHW, as described with reference to FIG. 7, HWRT is executed, in which a ray R is allowed to extend in a pseudo manner toward a virtual three-dimensional space in which processing blocks BL are disposed through control by the HWRT processing control unit 91 to calculate a position in the three-dimensional space, at which a collision of the ray R occurs. When the ray R has collided with a processing block BL, as a result that the processing in the RT core 12H has been executed (in the example illustrated in FIG. 5, the processing block BL2), a state transition condition C1 is satisfied. A transition to a WALK processing state SSW then becomes possible.

The WALK processing state SSW is a state where the WALK processing unit 92 is functioning, and a state where the WALK processing described above is executed. In the WALK processing state SSW, as described with reference to FIG. 7, processing of allowing the ray R to advance in a unit of each of voxels VC in the processing block BL is executed. As the processing in the CU 12S (software processing), when it is determined that a voxel VC belongs to a block BL that is different from the processing block BL, a state transition condition C2 is satisfied. A transition to the HWRT processing state SHW then becomes possible. Furthermore, as the processing in the CU 12S (software processing), when it is determined that the voxel VC belongs to a block BL that is different from the processing block BK, a state transition condition C3 is satisfied. A transition to the WALK processing state SSW then occurs, and the WALK processing state SSW is maintained.

The HWRT/WALK switching unit 93 executes control of the state transition conditions C1 to C3 described above.

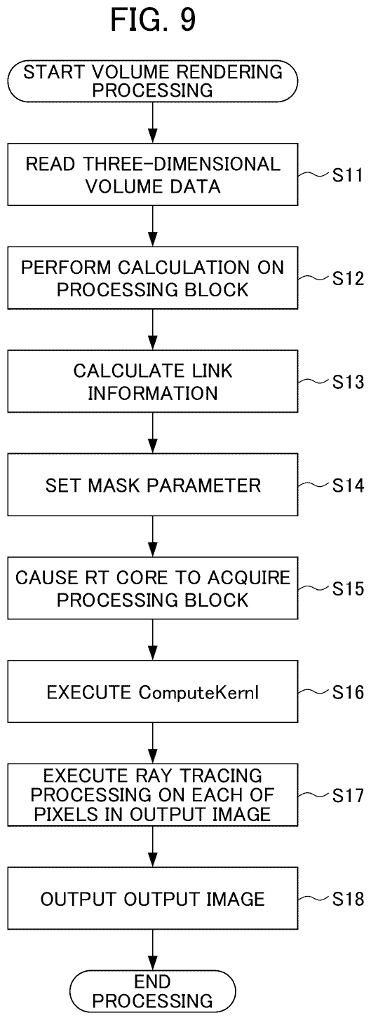

FIG. 9 is a flowchart for describing an example of a flow of the volume rendering processing executed by the rendering device having the functional configuration illustrated in FIG. 7. At a timing when a predetermined operation, for example, for executing processing corresponding to step ST2 illustrated in FIG. 1, that is, processing of volume rendering from the volume data VD is performed, the volume rendering processing is started, and steps S11 to S18 in the processing described below are executed.

That is, in step S11, the volume data management unit 51 reads the three-dimensional volume data VD relating to the target T that is subject to the volume rendering processing.

Next, in step S12, the block format conversion unit 61 calculates, based on a slice SLk included in the three-dimensional volume data VD, density in each of voxels VC included in the slice SLk. Furthermore, the processing block calculation unit 62 regards, among a plurality of the blocks forming the slice SLk, one or more of the blocks, in which a region corresponding to a part of the target T (an object of the part) may be included, as processing blocks BL and others of the blocks as pass-through blocks BLK.

Next, in step S13, the link calculation unit 63 calculates, as link information, information of other ones of the processing blocks BL adjacent to one of the processing blocks BL.

Next, in step S14, the mask setting processing unit 64 executes, based on the density in each of an n-number of the voxels VC included in the processing block BL, processing of regarding the density in one of the voxels, which represents the processing block BL, as a representative value, and of setting the first parameter.

Next, in step S15, the HWRT processing control unit 91 causes the RT core 12H to cause the processing block acquisition unit 111 to acquire the processing block BL.

Next, in step S16, the ComputeKernel execution control unit 53 performs control of executing the ComputeKernel 71.

Next, in step S17, the Computekernel 71 sequentially sets each of pixels forming an output image SG as a focusing-on pixel, and executes processing of determining a pixel value of the focusing-on pixel simultaneously, parallelly, and repeatedly.

Next, in step S18, the image output unit 82 outputs, as an output image SG, a result that processing of ray tracing for all the pixels has been completed.

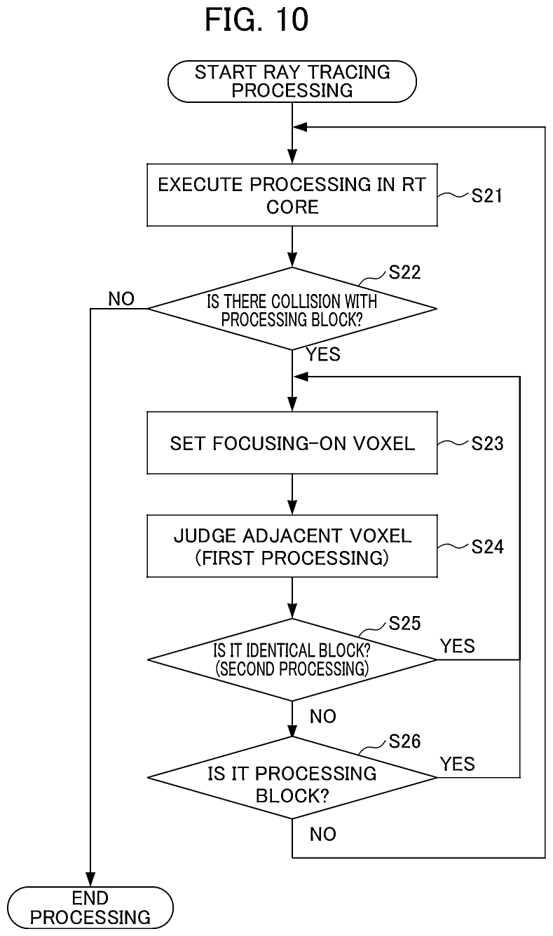

FIG. 10 is a flowchart for describing an example of a flow of ray tracing processing for each of pixels in an output image, in the flow of the volume rendering processing illustrated in FIG. 9.

When the Computekernel 71 determines a pixel value of a focusing-on pixel for each of pixels forming an output image SG in step S17 in the processing illustrated in FIG. 9, ray tracing processing illustrated in FIG. 10 is executed.

In step S21, the RT core 12H first executes the processing in the RT core 12H (hardware processing).

In step S22, the HWRT execution unit 112 determines whether or not the ray R that has been allowed to extend under the processing in the RT core 12H, which has been executed in step S21, has collided with a processing block BL. When the ray R has not collided with the processing block BL, NO is determined in the step S22 for the ray R in the focusing-on pixel, and the ray tracing processing for the focusing-on pixel ends.

In step S22, when the ray R has collided with the processing block (in the example illustrated in FIG. 4, the processing block BL1 and the processing block BL5), YES is determined in step S22, and the processing proceeds to step S23 to reflect the voxel VC included in the processing block BL on a pixel value of the focusing-on pixel.

In step S23, the WALK processing unit 92 sets, as a focusing-on voxel VC, a voxel VC, which lies on a straight line of the ray R, which starts from the predetermined point of view VP and passes through a predetermined pixel in an output image SG, in the processing block BL with which the ray R has collided in step S21.

Next, in step S24, the adjacent voxel judgment unit 101 judges, as the first processing, a voxel VC that is adjacent in the advancing direction of the ray R, when viewed from the focusing-on voxel VC.

Next, in step S25, the identical block determination unit 102 determines, as the second processing, whether or not the adjacent voxel VC is present in the identical processing block BL to which the focusing-on voxel VC belongs. When the adjacent voxel VC is present in the identical processing block BL to which the focusing-on voxel VC belongs, YES is determined in step S25, and the processing returns to step S23. As a result, steps S23 to S25 are executed repeatedly. At this time, in step S23, the adjacent voxel VC is set as a focusing-on voxel VC.

In step S25, when the adjacent voxel VC is not present in the identical processing block BL to which the focusing-on voxel VC belongs, NO is determined in step S25, and the processing proceeds to step S26.

Next, in step S26, the HWRT/WALK switching unit 93 judges whether or not a block, into which the ray R enters, next to the processing block BL while the ray tracing by the WALK processing (software processing) is executed is a processing block BL. When the block is a processing block BL, YES is judged in step S26, and the processing returns to step S23. As a result, steps S23 to S26 are executed repeatedly. At this time, in step S23, the adjacent voxel VC is set as a focusing-on voxel VC.

In step S26, when the block is not a processing block BL, that is, when the block is a pass-through block BLK, NO is determined in step S25, and the processing returns to step S21. As a result, in step S21, processing of allowing a ray R to extend from the processing block BL to which the focusing-on voxel VC belongs is executed. As a result, steps S21 to S26 are executed repeatedly.

As described above, in step S26, whether or not the processing in the RT core (hardware processing) is to be executed in step S21 differs depending on whether or not an adjacent voxel VC, when viewed from the focusing-on voxel VC, belongs to a processing block BL. Thereby, prohibition of an unnecessary transition from the WALK processing to the processing in the RT core is achieved. As a result, a period of time taken for the processing of ray tracing is shortened, leading to improved, efficient processing of generating an output image SG.

Although the embodiment of the present invention has been described, the present invention is not limited to the embodiment described above. The present invention is still deemed to include amendments and modifications, for example, that fall within the scope of the present invention, as long as it is possible to achieve the object of the present invention.

That is, for example, although, based on a slice SLk included in the three-dimensional volume data VD, the density in each of voxels VC included in the slice SLk has been calculated in the embodiment described above, the present invention is not particularly limited to the embodiment. That is, those that are subject to volume rendering are not limited to the density in each of voxels VC included in the three-dimensional volume data VD, and a desired parameter relating to each of the voxels VC may be adopted. Specifically, for example, a substance that forms a target T may be identified beforehand in a voxel VC (for example, whether or not it is iron or water), and information identifying the substance may be stored as volume data VD per voxel.

Furthermore, for example, although, in the embodiment described above, it has been described that the GPU 12 included in the rendering device 1 includes the RT core 12H, the present invention is not particularly limited to the embodiment. That is, it is enough that the rendering device 1 is able to execute processing that makes it possible to promptly calculate which position the ray advancing along a straight line collides with the target T is. That is, for example, the processing that makes it possible to promptly calculate which position the ray advancing along the straight line collides with the target T is may be executed by a field programmable gate array (FPGA), for example. Furthermore, for example, the processing that makes it possible to promptly calculate which position the ray advancing along the straight line collides with the target T is may be executed in another information processing device, instead of the GPU 12 provided in the rendering device 1. That is, it is enough that the rendering device 1 is able to execute processing via an application programming interface (API) for executing the processing that makes it possible to promptly calculate which position the ray advancing along the straight line collides with the target Tis.

Furthermore, for example, although, in the embodiment described above, a processing block BL has included an n-number of voxels VC in total (n=8), where four in the direction along the axis X, four in the direction along the axis Y, and one in the direction along the axis Z, the present invention is not particularly limited to the embodiment. The letter “n” represents a desired number, and it is not necessary that the number of voxels VC that are present in the direction along the axis X and the number of voxels VC that are present in the direction along the axis Y coincide with each other. Furthermore, the number of voxels VC that are present in the direction along the axis Z is not limited to one, and the number may be a desired positive integer value.

Furthermore, although, in the embodiment described above, the mask in the volume rendering has been applied by using the density of a target T, the present invention is not particularly limited to the embodiment. That is, for example, a mask using various types of parameters relating to a target T may be applied.

Specifically, for example, it is possible to adopt, as a parameter, a color of a substance forming a target T. In this case, each of a plurality of voxels VC is linked with a value of the color of the substance forming the target T (for example, values of RGB). Then, for example, to grasp how a red substance is disposed in a target T (when such an output image SG is to be generated), a processing block BL that include no voxel VC linked to a value of red (that is, a processing block BL including a group of voxels VC linked to values of other colors than red) is identified to be a mask block. Thereby, the WALK processing on the processing block BL (a mask block) including no voxel VC linked to the value of red is skipped, leading to improved, efficient volume rendering.

Furthermore, although, in the embodiment described above, the specific examples of the first parameter and the second parameter have been described in the description of the mask parameters used for the mask in the volume rendering, the present invention is not particularly limited to the example described above. That is, it is enough that the mask parameters (the first parameter and the second parameter) are set to allow the mask to be executed in the volume rendering described above, that is, to allow a mask condition to be determined.

Furthermore, the hardware configuration of the rendering device 1 illustrated in FIG. 6 is a mere example used to achieve the object of the present invention, and the present invention is not particularly limited to the example.

Furthermore, the functional block diagram illustrated in FIG. 7 is a mere example, and the present invention is not particularly limited to the example. That is, it is enough that an information processing system has functions and databases that make it possible to wholly execute the series of processing described above, and functional blocks used to achieve the functions are not particularly limited to the example illustrated in FIG. 7. Furthermore, locations at which the functional blocks and the databases are present are not limited to the locations illustrated in the example illustrated in FIG. 7, and desired locations may be applied.

Furthermore, it is possible to use hardware or software to execute the series of processing described above. Furthermore, a single piece of hardware may configure one functional block. A single piece of software may configure one functional block. A combination of pieces of hardware and software may configure one functional block.

To execute, with software, the series of processing, a program configuring the software is installed into a computer from a network or a recording medium, for example. The computer may be such a computer incorporated in special hardware. Furthermore, the computer may be such a computer installed with various programs used to execute various functions, such as, in addition to servers, general-purpose smart phones and personal computers.

A recording medium storing such programs as described above may not only be a non-illustrated removable medium distributed separately from a device main body to provide the programs to each user, but also be a recording medium provided to each user in a state where the recording medium is assembled beforehand in the device main body, for example.

Note that, in the present specification, steps describing programs recorded in a recording medium include not only processes sequentially executed in a chronological order, but also processes that may not necessarily be executed in a chronological order, but may be executed in parallel or separately. Furthermore, in the present specification, the term “system” means a generic apparatus including a plurality of devices and a plurality of means, for example.

To summarize those described above, it is enough that the information processing system to which the present invention is applied takes a configuration as described below. The information processing device may still take one of various embodiments. That is, an information processing device (for example, the rendering device 1 illustrated in FIG. 7) to which the present invention is applied is
an information processing device including:
a GPU (for example, the GPU 12 illustrated in FIG. 7) including an RT core unit (for example, the RT core 12H illustrated in FIG. 7) that executes, in a hardware manner, ray tracing on a predetermined three-dimensional space (for example, the real space illustrated in FIG. 1) in which a target (for example, the target T illustrated in FIG. 1) is included; and a CPU (for example, the CPU 11 illustrated in FIG. 7) that executes information processing, in which
it is enough that the CPU or the GPU includes:
an acquisition unit (for example, the volume data management unit 51 illustrated in FIG. 7) that acquires, when a three-dimensional body having a predetermined size is regarded as a unit three-dimensional body (for example, the voxel VC illustrated in FIG. 2), data in which the predetermined three-dimensional space is divided into a plurality of the unit three-dimensional bodies, as first data (for example, the volume data VD illustrated in FIG. 1); a second data generation unit (for example, the block format conversion unit 61 and the processing block calculation unit 62 illustrated in FIG. 7) that divides, when an n-number of the unit three-dimensional bodies are regarded as a block (for example, the processing blocks BL1 to BL7 and the pass-through block BLK illustrated in FIG. 3), the first data into a plurality of the blocks, that identifies, among the plurality of blocks, one or more of the blocks, the one or more of the blocks each including the unit three-dimensional body corresponding to a part of the target, as processing blocks (for example, the processing blocks BL1 to BL7 illustrated in FIG. 2), and identifies other ones of the blocks as pass-through blocks (for example, the pass-through blocks BLK illustrated in FIG. 2), and that generates, as second data, the first data divided into the processing blocks or the pass-through blocks; and an execution control unit (for example, the ComputeKernel 71 illustrated in FIG. 7) that controls execution of ray tracing on the second data, and
the execution control unit includes:
a ray tracing execution control unit (for example, the HWRT processing control unit 91 illustrated in FIG. 7) that executes control of executing ray tracing by the RT core unit on the pass-through blocks in the second data;
a software execution unit (for example, the WALK processing unit 92 illustrated in FIG. 7) that executes ray tracing by software processing on the second data; and
a switching unit (for example, the HWRT/WALK switching unit 93 illustrated in FIG. 7) that, while the ray tracing by the RT core unit is executed (for example, in the case of the HWRT state SHW illustrated in FIG. 8), when a ray enters one of the processing blocks (for example, when the state transition condition C1 illustrated in FIG. 8 is satisfied), causes switching to the ray tracing by the software processing to occur (for example, a transition to the WALK processing state SSW illustrated in FIG. 8 to occur), and, while the ray tracing by the software processing is executed (for example, when the state transition condition C2 illustrated in FIG. 8 is satisfied), when the ray enters one of the pass-through blocks (for example, in the case of the WALK processing state SSW illustrated in FIG. 8), causes switching to the ray tracing by the RT core unit to occur (for example, a transition to the HWRT state SHW illustrated in FIG. 8 to occur), or, when the ray enters an adjacent one of the processing blocks (for example, when the state transition condition C3 illustrated in FIG. 8 is satisfied), prohibits switching to the ray tracing by the RT core unit from occurring (for example, maintains the WALK processing state SSW illustrated in FIG. 8). Thereby, prohibition of an unnecessary transition from the ray tracing by software processing to the ray tracing by the RT core unit is achieved. As a result, a period of time taken for the processing of ray tracing is shortened, leading to improved, efficient processing of volume rendering.

The CPU or the GPU further includes:

an adjacent information generation unit (for example, the link calculation unit 63 illustrated in FIG. 7) that generates, for each of the one or more processing blocks included in the second data, information relating to an adjacent processing block (for example, the processing block BL2 that is adjacent to the processing block BL1 illustrated in FIG. 2) as adjacent information (for example, link information described in the present specification), in which the switching unit identifies, based on the adjacent information, whether or not the ray has collided with one of the pass-through blocks or collided with an adjacent one of the processing blocks. Thereby, whether or not an adjacent processing block is a pass-through block is identified based on adjacent information generated beforehand in software processing. Since the adjacent information generated beforehand is used, identification is efficiently performed, and a period of time taken for the processing of ray tracing is shortened, leading to improved, efficient processing of volume rendering.

The CPU or the GPU further includes:
a mask identification unit (for example, the mask setting processing unit 64 and the HWRT/WALK switching unit 93 illustrated in FIG. 7) that identifies, when a value of a predetermined parameter (for example, density or a color of a part of the target T) relating to the target is linked beforehand to each of the plurality of unit three-dimensional bodies included in the first data,
one of the processing blocks, among the plurality of processing blocks, the one of the processing blocks having the value of the parameter, the value of the parameter dissatisfying a predetermined condition (for example, when a value of density is below a certain value or a value of a color other than a value of a predetermined color) as a mask block, in which the switching unit prohibits, when the ray tracing by the RT core unit is executed, when the ray has collided with one of the processing blocks, and when the one of the processing blocks, with which the ray has collided, is the mask block, switching to the ray tracing by the software processing from occurring. Thereby, the ray tracing by software processing is not executed for a mask block having a parameter that does not satisfy a predetermined condition. As a result, a period of time taken for the processing of ray tracing is shortened, leading to improved, efficient processing of volume rendering.

The switching unit further prohibits, when the software processing is executed on a first processing block, when the ray has entered an adjacent second processing block, and when the second processing block to which the ray has entered is the mask block, the software processing on the mask block from occurring. Thereby, when software processing has been executed, ray tracing by software processing is prohibited for an adjacent mask block. As a result, a period of time taken for the processing of ray tracing is shortened, leading to improved, efficient processing of volume rendering.

Furthermore, it is possible that the parameter having the value linked to each of the unit three-dimensional bodies be density of the target. Thereby, processing of volume rendering for a target having the distribution of density is improved in efficiency.

### EXPLANATION OF REFERENCE NUMERALS

1 Rendering device, 11 CPU, 12 GPU, 12S CU, 12H RT core, 19 Storage unit, 21 Drive, 31 Removable medium, 51 Volume data management unit, 52 Block data generation unit, 53 ComputeKernel execution control unit, 54 Output image management unit, 61 Block format conversion unit, 62 Processing block calculation unit, 63 Link calculation unit, 64 Mask setting processing unit, 71 ComputeKernel, 81 Ray tracing execution control unit, 82 Image output unit, 91 HWRT processing control unit, 92 WALK processing unit, 93 HWRT/WALK switching unit, 101 Adjacent voxel judgment unit, 102 Identical block determination unit, 111 Processing block acquisition unit, 112 HWRT execution unit, 113 Processing block collision information providing unit, 200 Three-dimensional volume data DB, 300 Output image DB

1. An information processing device comprising:
a graphics processing unit (GPU) including a ray tracing (RT) core unit that executes, in a hardware manner, ray tracing on a predetermined three-dimensional space in which a target is included; and
a central processing unit (CPU) that executes information processing, wherein
the CPU or the GPU comprises:
an acquisition unit that acquires, when a three-dimensional body having a predetermined size is regarded as a unit three-dimensional body, data in which the predetermined three-dimensional space is divided into a plurality of the unit three-dimensional bodies, as first data;
a second data generation unit that divides, when an n-number of the unit three-dimensional bodies are regarded as a block, the first data into a plurality of the blocks, that identifies, among the plurality of blocks, one or more of the blocks, the one or more of the blocks each including the unit three-dimensional body corresponding to a part of the target, as processing blocks, and identifies other ones of the blocks as pass-through blocks, and that generates, as second data, the first data divided into the processing blocks or the pass-through blocks; and
an execution control unit that controls execution of ray tracing on the second data, and
the execution control unit includes:
a ray tracing execution control unit that executes control of executing ray tracing by the RT core unit on the pass-through blocks in the second data;
a software execution unit that executes ray tracing by software processing on the second data; and
a switching unit that, while the ray tracing by the RT core unit is executed, when a ray enters one of the processing blocks, causes switching to the ray tracing by the software processing to occur, and, while the ray tracing by the software processing is executed, when the ray enters one of the pass-through blocks, causes switching to the ray tracing by the RT core unit to occur, or, when the ray enters an adjacent one of the processing blocks, prohibits switching to the ray tracing by the RT core unit from occurring.

2. The information processing device according to claim 1, the CPU or the GPU further comprising
an adjacent information generation unit that generates, for each of the one or more processing blocks included in the second data, information relating to an adjacent processing block as adjacent information,
wherein the switching unit identifies, based on the adjacent information, whether or not the ray has collided with one of the pass-through blocks or collided with an adjacent one of the processing blocks.

3. The information processing device according to claim 1, the CPU or the GPU further comprising
a mask identification unit that identifies, when a value of a predetermined parameter relating to the target is linked beforehand to each of the plurality of unit three-dimensional bodies included in the first data,
one of the processing blocks, among the plurality of processing blocks, the one of the processing blocks having the value of the parameter, the value of the parameter dissatisfying a predetermined condition, as a mask block,
wherein the switching unit prohibits, when the ray tracing by the RT core unit is executed, when the ray has collided with one of the processing blocks, and when the one of the processing blocks, with which the ray has collided, is the mask block, switching to the ray tracing by the software processing from occurring.

4. The information processing device according to claim 3, wherein the switching unit further prohibits, when the software processing is executed on a first processing block, when the ray has entered an adjacent second processing block, and when the second processing block to which the ray has entered is the mask block, the software processing on the mask block from occurring.

5. The information processing device according to claim 3, wherein the parameter having the value linked to each of the unit three-dimensional bodies is density of the target.

6. An information processing method executed by an information processing device including:
a graphics processing unit (GPU) including a ray tracing (RT) core unit that executes, in a hardware manner, ray tracing on a predetermined three-dimensional space in which a target is included; and
a central processing unit (CPU) that executes information processing, comprising, comprising, as steps that the CPU or the GPU executes:
an acquisition step of acquiring, when a three-dimensional body having a predetermined size is regarded as a unit three-dimensional body, data in which the predetermined three-dimensional space is divided into a plurality of the unit three-dimensional bodies, as first data;
a second data generation step of dividing, when an n-number of the unit three-dimensional bodies are regarded as a block, the first data into a plurality of the blocks, of identifying, among the plurality of blocks, one or more of the blocks, the one or more of the blocks each including the unit three-dimensional body corresponding to a part of the target, as processing blocks, and identifying other ones of the blocks as pass-through blocks, and of generating, as second data, the first data divided into the processing blocks or the pass-through blocks; and
an execution control step of controlling execution of ray tracing on the second data, and
wherein the execution control step includes:
a ray tracing execution control step of executing control of executing ray tracing by the RT core unit on the pass-through blocks in the second data;
a software execution step of executing ray tracing by software processing on the second data; and
a switching step of, while the ray tracing by the RT core unit is executed, when a ray enters one of the processing blocks, causing switching to the ray tracing by the software processing to occur, and, while the ray tracing by the software processing is executed, when the ray enters one of the pass-through blocks, causing switching to the ray tracing by the RT core unit to occur, or, when the ray enters an adjacent one of the processing blocks, prohibiting switching to the ray tracing by the RT core unit from occurring.
